(19) United States
(12) Patent Application Publication
(10) Pub. No.: US 2003/0229895 A1
(43) Pub. Date: Dec. 11, 2003

(54) Anticipatory content augmentation

(75) Inventors: Radu S. Jasinschi, Ossining, NY (US); Nevenka Dimitrova, Yorktown Heights, NY (US); John Zimmerman, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N. V. Corporation

(21) Appl. No.: 10/165,931

(22) Filed: Jun. 10, 2002

(51) Int. Cl. H04N 5/445; H04N 7/173; H04N 7/10; H04N 7/025

(52) U.S. Cl. 725/46; 725/110; 725/34

(57) ABSTRACT

A method and apparatus for providing anticipatory content augmentation includes: (a) storing user personal preference requests as items in a Content Preference File (CPF); (b) updating the CPF in accordance with subsequent personal requests that are incremental of the personal preference requests from step (a); (c) categorizing the personal preference requests stored and updated in the CPF into lists, and weight-basing specific personal preference requests on the lists; (d) dynamically linking items categorized in step (c); (e) determining whether steps (a)-(d) have recorded predetermined threshold criteria; and repeating steps (a)-(d) if the threshold has not been reached; (f) identifying the CPF as a master CPF when it has been determined in step (e) that the predetermined threshold has been reached; (g) matching content of a program being viewed to the master CPF; (h) initiating searches in a database/network for augmented information for items identified in the content of the program that are also found in the master CPF; and (i) providing search results as anticipatory augmented content for items in the program being viewed. The user can be prompted with the information while viewing, during breaks in a program, or by user request.

### BACKGROUND OF THE INVENTION

1. Field of the Invention

The invention relates to processes and systems used to generate, update and transform TV/Web personalized information delivery. More particularly, the present invention relates to a process that anticipates content augmentation of a viewer.

2. Description of the Related Art

In the prior art, typically at a user/viewer end, a set-top box has been used to produce personal profiles. For example, in TiVo™ systems, personal digital recorders have been used to record entire television programs based on the user input of personal preferences. In addition, more complex systems use video content augmentation (VCA). Video content augmentation corresponds to TV program data that is relevant content information. Content augmentation provides a novel approach to contextual information extraction and delivery. The content of the TV program provides context, and augmenting information is tailored based on user preferences. This technology allows content providers to insert additional information after production. Users experience fast access to information and an enriched TV experience.

### SUMMARY OF THE INVENTION

Accordingly, the present invention includes a process and a system for anticipatory video content augmentation (AVCA), heretofore unknown.

In one aspect of the present invention, the system anticipates the content augmentation by initiating local or web searches for programs that a viewer has just started watching.

For example, the user begins to watch a basketball game (the basketball game can be identified via the Electronic Programming Guide (EPG)). The system will search for and/or retrieve sports statistics about the two basketball teams, the players, the league, other teams in the league, memorable past games between the two teams and/or other teams. The search can be conducted across, for example, the Internet via a search engine. The system may also directly access predetermined sites that provide such information (for example, a website for professional basketball that has specialized databases).

In another aspect of the present invention, the system begins searching for augmented information even prior to the program being watched, by communicating with a recommender system and anticipating programs that the user might like.

For example, the user can explicitly input likes and dislikes into the system, or the system may implicitly infer likes and dislikes from a viewing pattern. Of course, a combination of explicit and implicit preferences can be used to anticipate whether the user may watch the basketball game. In the case of the basketball game, the system checks the EPG and anticipates content augmentation requests because the user may watch the basketball game. Before the user even turns on the game, and shortly before its scheduled start, the system may search the Internet and/or other specialized databases for information that will be available to the user as soon as he/she turns on the game. Thus, the content augmentation is anticipated. This information can be prompted to the user or provided by user initiation.

The predetermined threshold criteria may comprise determining a degree of convergence between the categories. The predetermined threshold can comprise a predetermined number of passes. Alternatively, or in addition thereto, the predetermined threshold criteria may comprise an amount of time elapsed from the steps.

The linking in step can be performed by fusion. In addition, the search results provided for in step (i) can be automatically provided to the user, or prompted the user to ascertain whether it is desired to view the search results.

The user can be provided with the search results only when there is a break in the program being viewed. Alternatively, the user can be prompted only when there is a break in the program being viewed.

While the invention is not to be limited to sporting events and has applications in many different categories of programs, in the example regarding sporting events (such as the basketball game) it is envisioned that the program the search results provided in step (i) may comprise statistics that are associated with the sporting event. The search results provided in step (i) also include merchandise associated with the sporting event.

### BRIEF DESCRIPTION OF THE DRAWINGS

FIGS. 1A-1C are flowcharts providing an overview of an aspect of the present invention.

FIG. 2 illustrates a block diagram of one aspect of hardware operation according to the present invention.

### DETAILED DESCRIPTION OF THE INVENTION

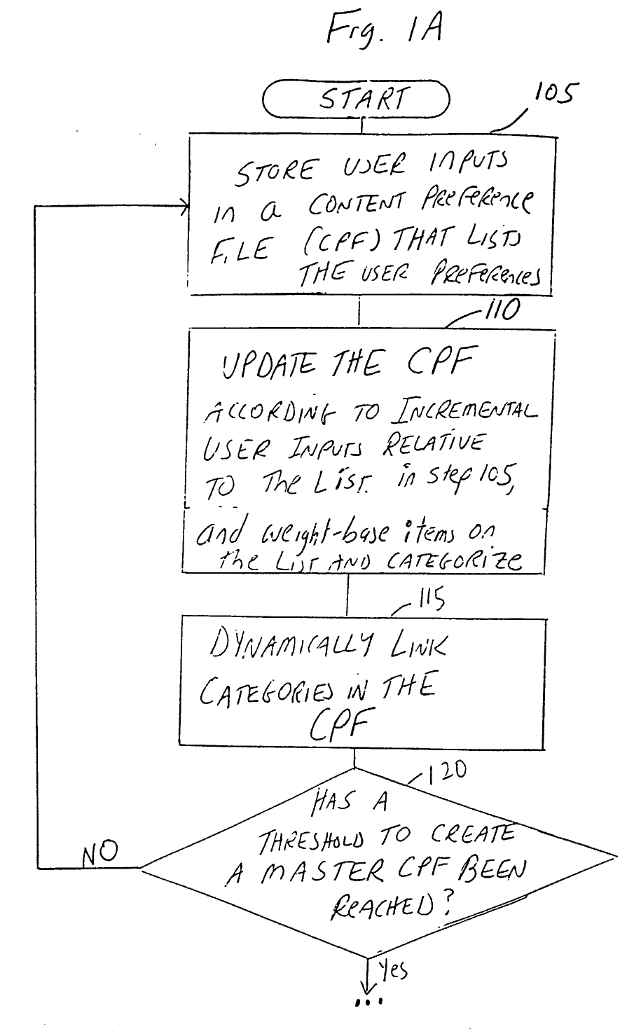

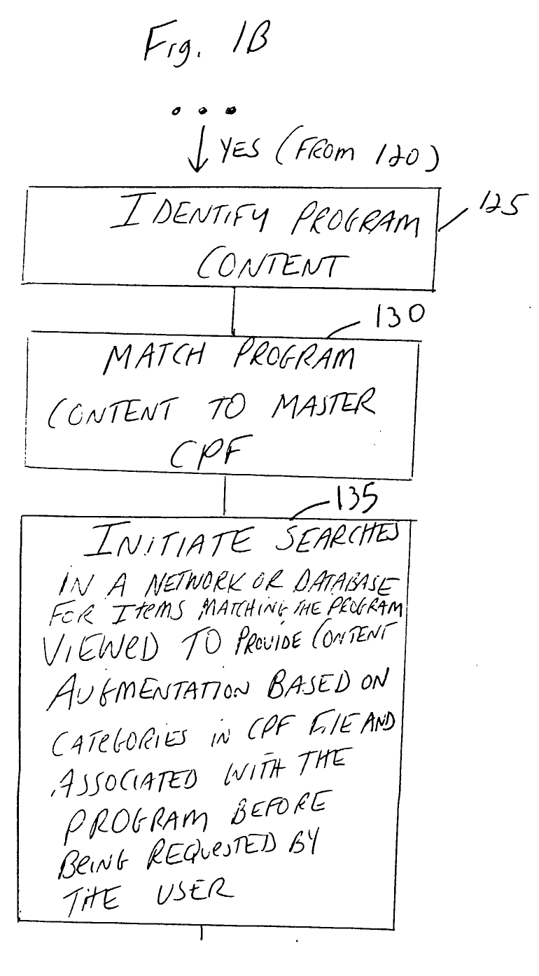

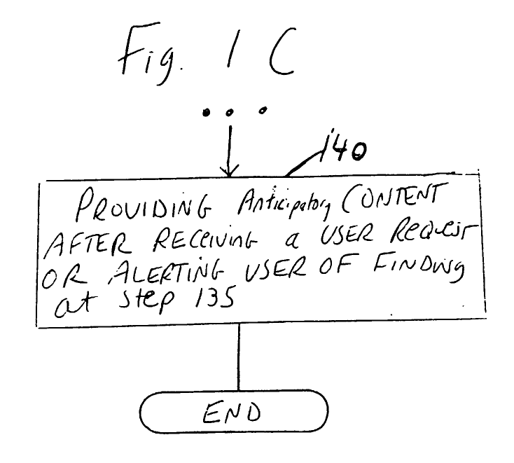

FIGS. 1A to 1C provide an overview of an aspect of a method according to the present invention. In this particular example, the user actively (explicitly) inputs preferences into the system, but a person of ordinary skill in the art understands that the present invention is not limited to explicit input of preferences, as these preferences can be inferred from the user's viewing history, or a combination of viewing history and explicit preferences can be used.

At step 105, the user inputs of preferences are stored in a Content Preference File (CPF).

At step 110, the CPF is updated as the user provides additional inputs associated with the CPF. The additional inputs can be entered over a period of time, or as the user continues to provide information during the initial provision of preferences. With additional inputs, there may be additional categories/lists that are stored in the CPF.

Part of the updating process at step 110 may include ranking the preferences indicated by the user. A weight-based system can be used, where preferences having more subsequent/incremental preferences can be weighted higher than others that might not have any incremental information input by the user.

At step 115, there is a dynamic linking of categories in the CPF. For example, if the user expresses an interest in basketball and football, these categories could be linked and there could be a weighting towards other sporting events, such as soccer, Olympic coverage, etc. In addition, there could be linkage of more diverse categories, such as music videos and movies that have a sound track with a similar type of music.

At step 120, there is a determination made as to whether a threshold as been reached with regard to the creation of a master CPF. Until the threshold is reached, steps 105 to 115 repeat.

The significance of reaching the threshold of inputs and updates reach the level of a master CPF is that this master CPF is utilized by the system for the anticipatory content augmentation. For example the master CPF is used (at step 125) identify television program content (e.g. closed captioned keywords); at step 130, the master CPF is used to match the output of the television program content identified at step 125 with a list in the master CPF.

At step 135 there is an anticipation of content augmentation requests by initiating searches in a network or database (local or Web) searches for, in the case of the basketball game being watched or likely to be watched, sports statistics related to the teams, game, sport, etc.

With regard to step 140, there are actually at least two modes that can be in operation after step 135. In a first mode, the system waits for the user to request the content augmentation. In a second mode, the system triggers an alert to the user about one or more matching items from step 130.

The system will monitor either periodically or continuously to determine whether the user has begun to ask for augmented content information. When it is determined that the user has received/asked for augmented content information, a next (e.g. subsequent) level of information is made available to the user as the previous level of information is provided.

It should be understood by artisans of ordinary skill that the content information can be provided to the user, or prompted to the user, during commercial breaks, station breaks, etc. It is known in the art to identify a station break/commercial break, either by the feed coming from the cable/broadcast/satellite system, such as the change in audio, closed captioned text, audio, etc.

With regard to recognizing a station break, as disclosed in “Apparatus and Method for Locating a Commercial Disposed Within a Video Data Stream,” invented by: Nevenka Dimitrova, Thomas McGee, Herman Elenbaas, Eugene Leyvi, Carolyn Ramsey and David Berkowitz, Filed Jul. 28, 1998, U.S. Pat. No. 6,100,941, the contents of which are hereby incorporated by reference, discloses that means for analyzing video data, which can be applied to determine breaks in the program being viewed.

Pause detection can be used to determine that a commercial break/station break has occurred. Thus, a pause is a time period where there is a lack of sound (or a lack of sound detected by the listener). As noted in the Classification of General Audio Data for Content-Based Retrieval (D. Li, I. K. Sethi, N. Dimitrova, and T. Mcgee, “Classification of general audio data for content-based retrieval,” Pattern Recognition Letters, pp. 533-544, Vol. 22, No. 5, April 2001), the pause detector generates results consistent with human perception.

Once there has been determined that a break has occurred, the user could be provided with, or prompted if they desire, information related to the program, such as biographies, sports statistics (if the program is a sporting event), memorabilia, etc. Of course, this scenario is specified in the user preferences as non-disruptive. If the user has specified disruptive mode of content augmentation, the notification can happen during regular programs via audio or visual signal.

The anticipatory augmentation can happen based on the temporal distance to the event. For example, before the “Academy awards,” all the nominated actors and directors appear on various talk shows or in entertainment magazine type of shows both on TV and radio. The source for content augmentation are other TV programs prior to the event and also various related Web pages. The system extracts high level abstracted information from the underlying content and matches this information with the information from the external (other sources). For example, the system finds the names of the nominated actors/actresses, producers, directors, special effects experts that are nominated and finds relevant segments in various TV programs using the names of these celebrities. Video content segmentation and indexing is described in: Elenbaas, J H; Dimitrova, N; Mcgee, T; Simpson, M; Martino, J; Abdel-Mottaleb, M; Garrett, M; Ramsey, C; Desai, R, Personalized Video Classification And Retrieval System , EP 1 057 129 A1, Dec. 6, 2000, and inMethod and Apparatus for Audio/Data/Visual Information Selection, Nevenka Dimitrova, Thomas McGee, Herman Elenbaas, Radu Jasinschi, Lalitha Agnihotri, Serhan Dagtas, Aaron Mendelsohn, PHA 23,847, filed Nov. 18, 1999, Ser. No. 09/442,960. Once those segments are identified and linked with the celebrity name, the system stores them in anticipation with the real event (the Academy awards).

In addition to the talk show segments of shows prior to the Academy awards, the system tracks different Web sites, such as the web site of People Magazine. So, for each type of event/program, the system keeps information about the time during which it needs to track and retrieve information from outside sources. For example, for sporting events, the system can use information extraction from the Web and retrieve information only 10 minutes before the game. For Academy awards type of shows, the system needs to monitor all TV channels for two weeks before the show. From user's perspective, the user needs to give a guideline on what type of sources the system should track. For example, track and get information from the New York Times Web site and not a tabloid Web site.

Therefore, the present invention can be tailored not only to specify the time length in advance that the system needs for augmentation, but the time length is settable according to any of: show specific, genre specific, or topic specific.

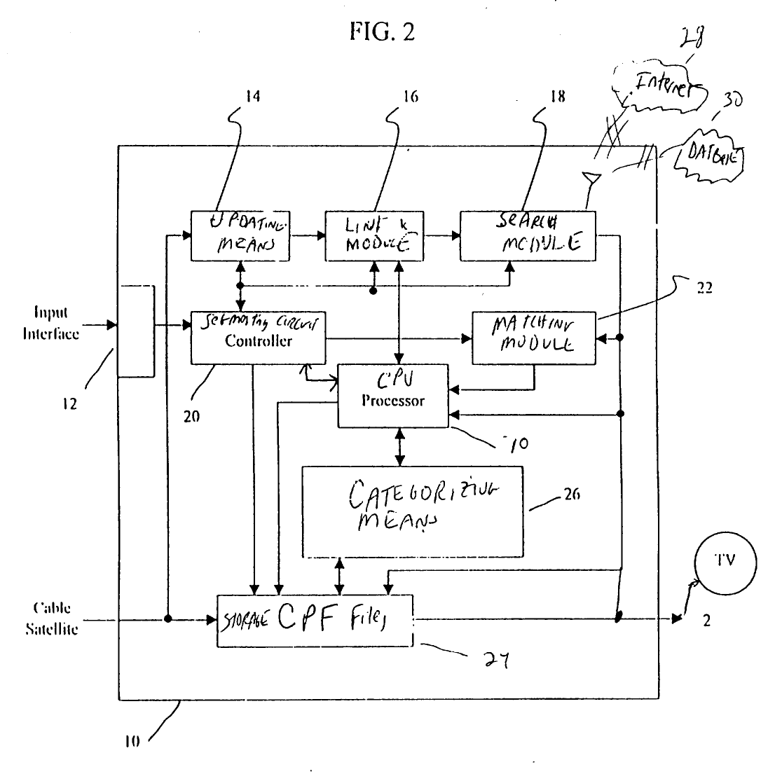

FIG. 2 illustrates a simplified block diagram of a system and/or device that provide all of the hardware functions of the present invention. At the heart of the device is a cpu/processor 10. An input interface (i.e. infrared sensor 12) can be used to enter personal preference requests that are stored in a content preference file 24 via controller 20. As additional/subsequent inputs are made, the CPF file is updated via updating means. A categorizing means 26 analyzes the preference requests and categorizing them according to some common thread. Link module 16 links all the categorized preference requests. The processor keeps track as to whether predetermined threshold criteria identifying the CPF files as master CPF files. The Master CPF is then used to compare against a program being viewed by TV (could be broadcast, video tape, etc.) to ascertain whether there is any matching criteria of any content in the program being viewed as detected by segmenting circuit 20 being viewed with the Master CPF file by matching module 22. Search module 18 then performs database searches with any of Internet, Lan, Wan, ISP, to find augmented information for items identified in the content of the program that are also found in the Master CPF. The results of the search module can then be displayed and/or prompted to the user on the TV 2. Alternatively, the augmented information can be stored in storage for retrieval upon request of the user, oir by an answer to his/her prompt.

Various modifications can be made by a person of ordinary skill in the art that would not depart from the spirit of the invention, or the scope of the appended claims. It is to be understood that for these reasons, the previous examples were provided for purposes of illustration, and not for limitation. For example, the time length in advance that the system needs for augmentation can be changed according to need or user preference. In addition, the choice of sources that the system searches in order to draw the anticipatory information can be from websites of: magazines, television shows, columnists (syndicated or not), trade publications, trade publications, talk-radio hosts, talk show hosts, sports related websites (such as the Major League BaseBall website, newswire organizations (such as the Associated Press, Yahoo, etc.). The quantity of retrieved information can be filtered by size, date, number of times an item is mentioned in a particular abstract, etc. Finally, the levels of detailed information (such as headlines and summaries vs. whole subtrees of Web pages) could be modified according to need or user preference.

What is claimed is:

1. A method for providing anticipatory content augmentation comprising:
(a) storing user personal preference requests as items in a Content Preference File (CPF);
(b) updating the CPF in accordance with subsequent personal requests that are incremental of the personal preference requests from step (a);
(c) categorizing the personal preference requests stored and updated in the CPF into lists, and weight-basing specific personal preference requests on the lists;
(d) dynamically linking items categorized in step (c);
(e) determining whether steps (a)-(d) have reached predetermined threshold criteria; and repeating steps (a)-(d) if the threshold has not been reached;
(f) identifying the CPF as a master CPF when it has been determined in step (e) that the predetermined threshold has been reached;
(g) matching content of a program being viewed to the master CPF;
(h) initiating searches in a database/network for augmented information for items identified in the content of the program that are also found in the master CPF; and
(i) providing search results as anticipatory augmented content for items in the program being viewed.

2. The method according to claim 1, wherein the predetermined threshold criteria comprises determining a degree of convergence between the categories.

3. The method according to claim 2, wherein the predetermined threshold comprises a predetermined number of passes of steps (a)-(d).

4. The method according to claim 1, wherein the predetermined threshold criteria comprise an amount of time elapsed from Step (a) to Step (d).

5. The method according to claim 2, wherein the linking in Step (d) is performed by fusion.

6. The method according to claim 1, wherein the search results provided for in Step (i) are automatically provided to the user.

7. The method according to claim 1, further comprising: (j) prompting the user to ascertain whether it is desired to view the search results.

8. The method according to claim 6, wherein the user is provided with the search results only when there is a break in said program being viewed.

9. The method according to claim 7, wherein the user is prompted only when there is a break in said program being viewed.

10. The method according to claim 1, wherein said program being viewed is a sporting event and the search results provided in step (i) comprise statistics that are associated with the sporting event.

11. The method according to claim 10, wherein the search results provided in step (i) also include merchandise associated with the sporting event.

12. The method according to claim 1, wherein the information is provided in step (i) only upon a user-initiated request.

13. The method according to claim 1, wherein the searches initiated in step (h) include determining a time period in advance of a scheduled program to perform augmentation.

14. The method according to claim 13, wherein the time period is determined according to one of (a) program specific; (b) genre specific; and (c) topic specific.

15. The method according to claim 14, wherein the time period to perform augmentation prior to a starting time of an event is a user-determined personal preference.

16. The method according to claim 1, wherein the areas searched in step (h) for augmentation are based on user-determined preferences for at least one of a particular program, genre, and topic.

17. The method according to claim 16, wherein the area searched includes an identity of particular information sources for searching.

18. The method according to claim 17, wherein the area searched is further defined by including an identity of additional information sources that are to be excluded from the searches.

19. The method according to claim 17, wherein the particular information sources are restricted to one of headlines and summaries.

20. The method according to claim 17, wherein the particular information sources are restricted to a number of levels of Web pages in the Web site hierarchy of Web pages.

21. The method according to claim 17, wherein the particular information sources are restricted to a subhierarchy (subtree) of Web pages in the Web site hierarchy of Web pages.

22. The method according to claim 17, wherein the particular information sources are restricted by dates.

23. The method according to claim 17, wherein the particular information sources are restricted by quantity.

24. The method according to claim 1, wherein the search results provided in step (i) are limited by quantity.

25. The method according to claim 1, further comprising identifying a maximum file size of augmented information provided in step (i).

26. The method according to claim 25, wherein the maximum file size is a total size of the search results in provided in step (i).

27. The method according to claim 25, wherein the maximum file size is an individual size limitation for each item found in the searches.

28. A device for providing anticipatory content augmentation comprising:
(a) means for storing user entered personal preference requests as items in a Content Preference File (CPF);
(b) means for updating the CPF in accordance with subsequent personal requests that are incremental of the personal preference requests from step (a);
(c) categorizing means for categorizing the personal preference requests stored and updated in the CPF storage 24 into lists, and weight-basing specific personal preference requests on the lists;
(d) a link module for dynamically linking items categorized by the categorizing means;
(e) means for determining by a processor whether a predetermined threshold criteria for content preference requests have been reached;
(f) identifying the CPF as a master CPF when it has been determined in (e) that the predetermined threshold has been reached;
(g) matching content of a program being viewed to the master CPF by a matching module;
(h) initiating searches in a database/network for augmented information for items identified in the content of the program detected by segmenting circuit that are also found in the master CPF by a search module; and
(i) the search module providing search results to the user as anticipatory augmented content for items in the program being viewed.

29. A system for providing anticipatory content augmentation comprising:
(a) means for storing user entered personal preference requests as items in a Content Preference File (CPF);
(b) means for updating the CPF in accordance with subsequent personal requests that are incremental of the personal preference requests from step (a);
(c) categorizing means for categorizing the personal preference requests stored and updated in the CPF storage 24 into lists, and weight-basing specific personal preference requests on the lists;
(d) a link module for dynamically linking items categorized by the categorizing means;
(e) means for determining by a processor whether a predetermined threshold criteria for content preference requests have been reached;
(f) identifying the CPF as a master CPF when it has been determined in (e) that the predetermined threshold has been reached;
(g) matching content of a program being viewed to the master CPF by a matching module;
(h) initiating searches in one of a database Internet for augmented information for items identified in the content of the program that has been segmented by segmenting circuit and are also found in the master CPF by a search module; and
(i) the search module providing search results to the user as anticipatory augmented content for items in the program being viewed; and
wherein the search module communicates with the one of the Internet and database by one of wireless, wired and fiber optic communication links.
